(19) United States
(12) Patent Application Publication
(10) Pub. No.: US 2026/0132744 A1
(43) Pub. Date: May 14, 2026

(54) OPTIMIZED SOUND ATTENUATION PANEL FOR AN AIRCRAFT TURBOMACHINE

(71) Applicant: SAFRAN NACELLES, GONFREVILLE-L'ORCHER (FR)

(72) Inventors: Marc VERSAEVEL, MOISSY-CRAMAYEL (FR); John MOUTIER, MOISSY-CRAMAYEL (FR)

(73) Assignee: SAFRAN NACELLES, GONFREVILLE-L'ORCHER (FR)

(21) Appl. No.: 19/123,140

(22) PCT Filed: Oct. 23, 2023
(86) PCT No.: PCT/FR2023/051653

§ 371 Date: Apr. 22, 2025

(30) Foreign Application Priority Data
Oct. 27, 2022 (FR) 2211216

(51) Int. Cl. F02C 7/24; B32B 3/12; B32B 3/26; B64D 27/10; B64D 29/00

(52) U.S. Cl. CPC F02C 7/24; B32B 3/12; B32B 3/266; B64D 27/10; B64D 29/00; B32B 2250/03; B32B 2250/40; B32B 2307/102; B32B 2307/7375; B32B 2605/18; F05D 2260/96

(57) ABSTRACT

A sound attenuation panel for an aircraft turbomachine includes first and second skins and a core comprising. The core has at least one polygonal cell provided with an internal cavity in communication with at least one hole formed in the first wall. The cavity has a first height (H1) between the first and second skins. Each cavity includes at least one internal partition that extends substantially from the first skin perpendicular to the first and second skins over a second height (H2) that is less than the first height (H1) and transversely between two side walls of the cell. The internal partition divides the cavity into at least two adjacent pockets in communication with one another and with the hole.

### TECHNICAL FIELD OF THE INVENTION

The invention relates to a sound attenuation panel for an aircraft turbomachine, and a method for manufacturing such a panel.

### TECHNICAL BACKGROUND

The prior art comprises the documents EP-2.478.202-B1, U.S. Pat. No. 9,514,734-B1, WO-2006/107.533-A2, US-2012/168248-A1 and EP-2.788.601-B1.

The sound attenuation panels are widely used in the turbomachines for lining areas subject to significant gas passages, such as an air inlet, a fan casing or a secondary flow duct located downstream of the fan in which air flows, or a turbomachine exhaust nozzle or plug, subject to exhaust gas passage.

These sound attenuation panels are generally made in the form of sandwiches comprising at least a first outer skin, a second internal skin, and a core trapped between these first and second skins. The core comprises a plurality of tubular polygonal cells, each of which has an orientation perpendicular to the first and second skins. These cores are generally made in the form of a plate of honeycomb material with hexagonal cells. These cells are hollow along their entire length.

The height of the cells determines the panel's capacity to absorb sound waves. In fact, the first skin, also known as the permeable sound skin, comprises a plurality of holes that open out inside the cells. The second skin is called the sound-reflective skin. It has been shown that sound waves are best absorbed when the height of the cells between the two skins is approximately a quarter of the wavelength of the sound wave to be treated.

At present, for reasons of integration and compactness, it is desirable to produce sound attenuation panels that are thinner than the conventional panels. However, it is not possible to reduce the height of the cells without losing the panel's capacity to absorb sound waves in the target frequencies.

There is therefore a real need for a sound-absorbing panel that is thinner than a conventional panel, yet retains the same level of sound attenuation.

### SUMMARY OF THE INVENTION

The invention satisfies this need by proposing a sound attenuation panel in which the cells are of reduced height and each provided with at least one internal partition enabling the sound wave to be offered a pathway in the cell which is the same length as a conventional cell.

For this purpose, the invention proposes a sound attenuation panel for an aircraft turbomachine, said panel comprising a first skin, a second skin, and a core sandwiched between the first and second skins, said core comprising a plurality of tubular polygonal cells which each have an orientation perpendicular to the first and second skins, each cell comprising an internal cavity which communicates with at least one hole formed in said first skin and which is delimited by side walls extending between the first and second skins and perpendicularly to the first and second skins, these side walls having a first height equal to a distance between the first and second skins, characterised in that each polygonal cell further comprises at least one internal partition inside its cavity, this internal partition extending substantially from the first skin perpendicular to the first and second skins along a second height less than the first height, and transversely in the cavity between two side walls of the cell, this internal partition dividing the cavity into at least two adjacent pockets and delimiting between a free end of said partition and the second wall a passage allowing the two adjacent pockets to communicate with each other and with said hole.

The sound attenuation panel according to the invention offers sound waves a pathway of the same length as a conventional panel by making the wave travel along two pockets of the same length. This configuration allows the panel to be equipped with cells of first height, twice less than a conventional panel, with the same sound absorption capacities as the latter.

According to other characteristics of the panel:
said at least one internal partition extends transversely between internal faces of two substantially opposite side walls of the cell,
said at least one internal partition extends transversely between an edge joining first and second side walls and a third side wall substantially opposite the first and second side walls,
said at least one internal partition extends transversely between an edge joining first and second side walls and an edge joining third and fourth side walls,
each polygonal cell is a regular polygonal cell having a central axis and comprises at least two partitions joined along said central axis,
each polygonal cell is a hexagonal cell,
each cell comprises as many internal partitions joined along the central axis as there are side walls,
each cell comprises an even number of side walls and the internal partitions extend transversely between said axis and the edges joining the side walls, delimiting as many pockets communicating with one another as there are side walls.
each cell comprises an even number of side walls, half as many partitions as side walls, and internal walls of the same first height as the side walls, which alternate around the central axis with said partitions so as to delimit pairs of adjacent communicating pockets, each pair of communicating pockets being isolated from the other pairs of communicating pockets and communicating with a hole in the first skin, the number of pairs of communicating pockets being haff the number of side walls,
the first height is equal to one eighth of a wavelength of the sound to be attenuated,
the cells of the core, the side walls and said at least one internal partition are obtained by an additive manufacturing method.
the cells of the core and the side walls are obtained by extrusion of a plastic material, said at least one internal partition is also obtained by extrusion of a plastic material, and said at least one internal partition is welded into each cell,
the cells of the core are obtained by supplying a conventional honeycomb material in which at least one insert forming said at least one partition is arranged,
the first height is between 20 and 50 mm,
the second height is greater than half the first height and at least 5 mm less than or equal to the first height.

The invention also relates to a method of manufacturing an attenuation panel of the type described above, characterised in that it comprises:
a first step of manufacturing a first skin,
a second step of manufacturing a second skin,
a third step of manufacturing the core by additive manufacturing, by extrusion and welding, or by supplying a conventional honeycomb material in which at least one insert forming said at least one partition is arranged,
a fourth step of fixing the first and second skins to the core by welding, brazing or gluing,
a fifth step of drilling the first skin, producing holes in said first skin, each of which opens into a pocket of a polygonal cell of the core.

Finally, the invention relates to a turbomachine, characterised in that it comprises at least one gas flow duct delimited by at least one wall comprising an attenuation panel of the type described above.

### BRIEF DESCRIPTION OF THE FIGURES

Further characteristics and advantages of the invention will become apparent from the following detailed description, for the understanding of which reference is made to the attached drawings wherein:

FIG. 1 is a schematic view of the locations of sound attenuation panels in a turbomachine and its nacelle;

FIG. 2 is a perspective view of a conventional sound attenuation panel;

FIG. 3 is a perspective view of a core of a conventional sound attenuation panel;

FIG. 4 is a perspective view of a cell with a hexagonal cross-section of a core of a sound attenuation panel according to the invention;

FIG. 5 is another perspective view of a hexagonal section cell of a core of a sound attenuation panel according to the invention;

FIG. 6 is a perspective view of a first end of a hexagonal-section cell of a core of a sound attenuation panel according to the invention;

FIG. 7 is a perspective view of a second end of a hexagonal section cell of a core of a sound attenuation panel according to the invention;

FIG. 8a is a top view of a first embodiment of the first end of a hexagonal section cell of a core of a sound attenuation panel according to the invention;

FIG. 8b is a top view of a second embodiment of the first end of a hexagonal section cell of a core of a sound attenuation panel according to the invention;

FIG. 8c is a top view of a third embodiment of the first end of a hexagonal section cell of a core of a sound attenuation panel according to the invention;

FIG. 8d is a top view of a fourth embodiment of the first end of a hexagonal section cell of a core of a sound attenuation panel according to the invention;

FIG. 9 The figure is a perspective view of the hexagonal section cell of FIG. 8d;

FIG. 10 is a perspective view of a rectangular cross-section cell of a core of a sound attenuation panel according to the invention;

FIG. 11 is a block diagram illustrating the steps of a first embodiment of a method of manufacturing a sound attenuation panel according to the invention;

FIG. 12 is a block diagram illustrating the steps of a second embodiment of a method of manufacturing a sound attenuation panel according to the invention.

### DETAILED DESCRIPTION OF THE INVENTION

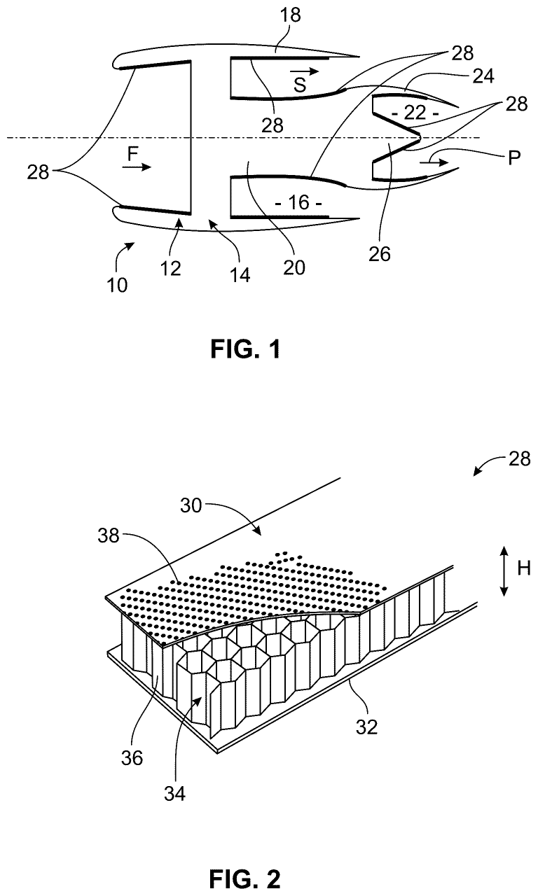

FIG. 1 shows a schematic diagram of a turbomachine 10. The turbomachine 10 comprises, from upstream to downstream, an air inlet 12, a casing 14, a secondary flow channel 16 delimited by an internal wall 20 and an outer wall 18, and a primary flow channel 22 bounded by an exhaust casing 24 and an exhaust cone 26, also known as plug.

The air inlet 12 is traversed by an incoming air flow F, the secondary flow channel 16 is traversed by a secondary air flow S and the nozzle 22 allows the ejection of a primary gas flow P.

The rotating parts of the engine are significant sources of noise. The noise from the fan propagates upstream in the counter current of the flow F in the air inlet 12 or downstream in the direction of the flow S in the secondary duct 16. The noise from the turbine is propagated in the flow P through the nozzle 22. To remedy this, the air inlet 12, the engine casing 14, the secondary flow channel 16 and the nozzle 22 can have their walls covered with sound attenuation panels. In this way, the air inlet 12, the walls 18 and 20 of the secondary flow, the exhaust casing 24 and the exhaust cone 26 can be covered by sound attenuation panels 28.

As illustrated in FIG. 2, such a panel 28 is generally made in the form of a sandwich comprising, in its simplest form, at least one first skin 30 oriented towards the incoming air flow F, the primary flow P or the secondary flow S, a second skin 32, and at least one core 34. Of course, the sandwich can comprise other intermediate layers and in particular other cores superimposed on the core 34.

The first skin 30 comprises holes or perforations 38 and is referred to as a permeable sound skin. The second skin 32 is closed and is referred to as the acoustically reflective skin.

The core 34 comprises a plurality of tubular polygonal cells 36, each oriented along an axis perpendicular A to the first and second skins. This core 34 is generally made in the form of a plate of honeycomb material with hexagonal cells 36, which are hollow over their entire height H, this height H corresponding to the distance between the first and second skins 30, 32. The first skin 30 comprises a plurality of holes or perforations 38 which open out inside the cells 36. The sound waves therefore penetrate the cells 36 through these holes or perforations 38.

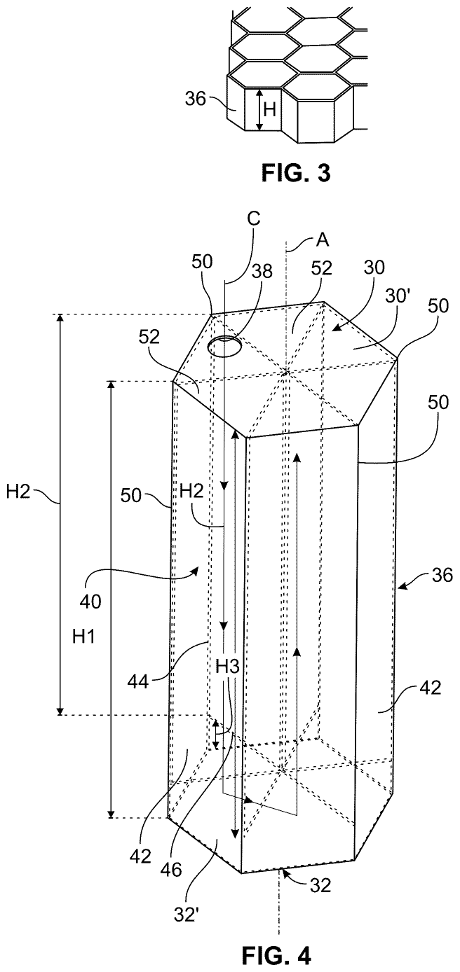

As shown in FIG. 3, the height H of the cells 36 is a key parameter that determines the capacity of the panel 28 to absorb sound waves. It has been shown that sound wave absorption is optimal for a conventional panel 28 when the cells 36 have a height H corresponding approximately to a quarter of the wavelength λ of the sound wave to be processed.

However, for reasons of integration and compactness, it is desirable to produce sound attenuation panels that are thinner than conventional panels. However, it is not possible to reduce the height of the cells 36 without altering the frequency behaviour of the panel 28. Any reduction in the height H of the core 34 shifts the peak attenuation of the panel towards higher frequencies, which are no longer part of the target frequency range.

The capacity of a cell to absorb a sound wave of wavelength λ is directly dependent on the length of the path travelled by the sound wave in cell 36, i.e., according to the above, a length corresponding to a quarter of the wavelength, i.e. λ/4. However, we have also seen that the length of this path does not necessarily have to be limited to a rectilinear path, in this case over the height H of the cell 36. In other words, the acoustic wave can be effectively absorbed as long as the total length of the path travelled is close to λ/4, but this length can be distributed along a non-rectilinear path.

The invention therefore advantageously offers a sound attenuation panel 28 that is thinner than a conventional panel but retains the same level of acoustic attenuation and the same target frequency range. The cells 36 of this panel are partially partitioned to distribute the path of the sound waves along a first height H1 of the cell but in at least two adjacent pockets, and in this case the first height H1 can therefore be reduced compared with a conventional cell.

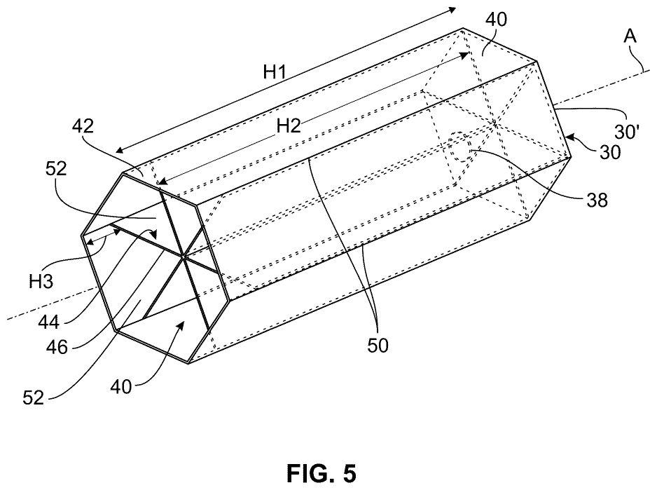

A cell 36 for a panel in accordance with the invention is shown in FIGS. 4 to 7 and 9. These figures show a unitary cell 36 sandwiched between a corresponding part 30′ of the first skin 30 and a corresponding part 32′ of the second skin 32, it being understood that the cells 36 are all obtained in a single manufacturing operation. The cell 36 shown here has a hexagonal cross-section, but it will be understood that this arrangement is not restrictive of the invention, and the invention can be applied to any cell with a polygonal cross-section, i.e. triangular, square, rectangular, pentagonal, octagonal, regular or irregular.

Each cell 36 comprises an internal cavity 40 which communicates with at least one of the holes 38 formed in the first skin 30 and which is bounded by side walls 42 extending between the first and second skins 30, 32 and perpendicularly to the first and second skins 30, 32. These side walls 42 have a first height H1 equal to the distance between the first and second skins 30, 32.

In accordance with the invention, each polygonal cell 36 also comprises at least one internal partition 44 inside the cavity 40. The internal partition 44 extends substantially towards the second skin 32 from the first skin 30, perpendicularly to the first and second skins 30, 32, at a second height H2 less than the first height H1. It therefore delimits a third-height passage H3 between the free end 46 of the partition 44 and the second skin 32.

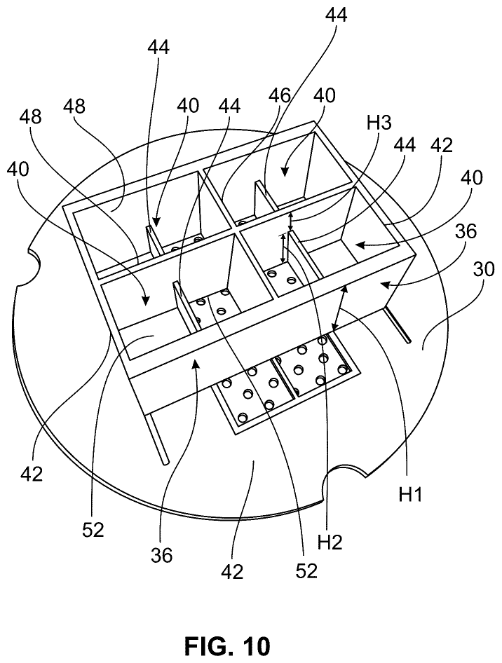

Said at least one partition 44 extends transversely into the cavity 40 between two side walls 42 of the cell 36, either between intermediate parts of the side walls 42, as shown in FIG. 10, or between edges 50 joining the side walls 42, as can be seen in FIGS. 4 to 8c.

As a result, the at least one partition 44 divides the cavity 40 into at least two adjacent pockets 52. The passage between the free end 46 of the partition 44 and the second wall 32 allows the two adjacent pockets 52 to communicate with each other and with the hole 38, as illustrated by the arrows showing the circulation C of the sound waves in FIGS. 4, 8a-8d and 9.

FIG. 10 shows a group of four cells 36 with rectangular cross-sections delimiting four cavities 40, each cavity 40 accommodating a partition 44 of the type described above.

The partitions 44 can extend transversely in different ways into the cavities 40. For example, as illustrated in FIG. 10, each internal partition 44 extends transversely between internal faces 48 of two substantially opposite side walls 42 of the cell 36. This configuration is particularly suitable for a cell 36 with an even number of side walls 42.

Alternatively (not shown), the at least one internal partition 44 could extend transversely between an edge joining first and second side walls and a third side wall substantially opposite the first and second side walls. This configuration is particularly suitable for a cell 36 with an odd number of walls, such as a triangular or pentagonal cell.

Alternatively, said at least one internal partition 44 may extend transversely between an edge joining the first and second side walls 42 and another edge joining third and fourth side walls 42.

A particular case of this cell 36 configuration is that of a regular polygonal cell 36 with a central axis A.

In this case, the cell 36 comprises not one but at least two partitions 44 joined along the central axis A. The cell 36 may have as many internal partitions 44 joined along the central axis 44 as there are side walls 42, whether or not the cell 36 has an even number of side walls 42.

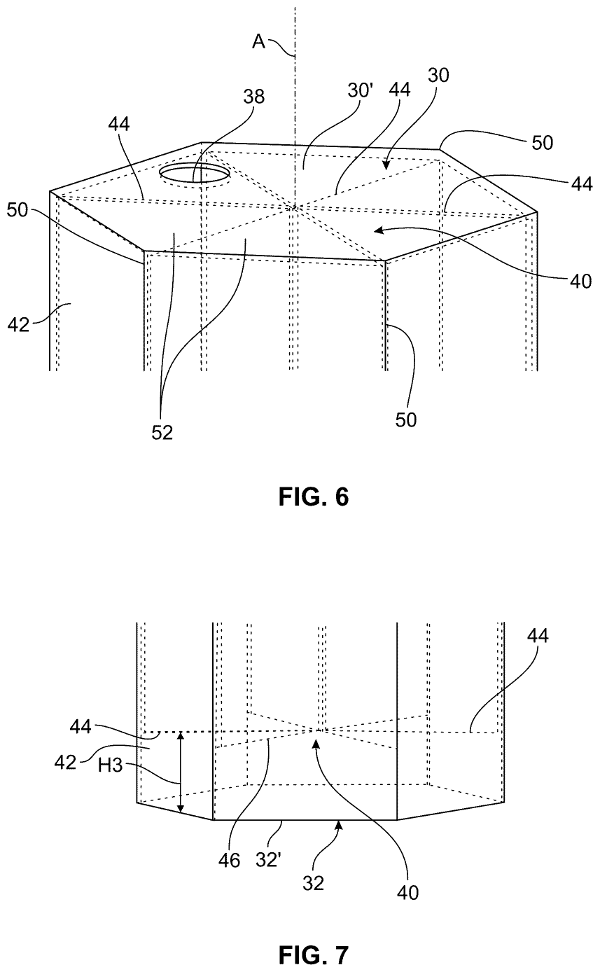

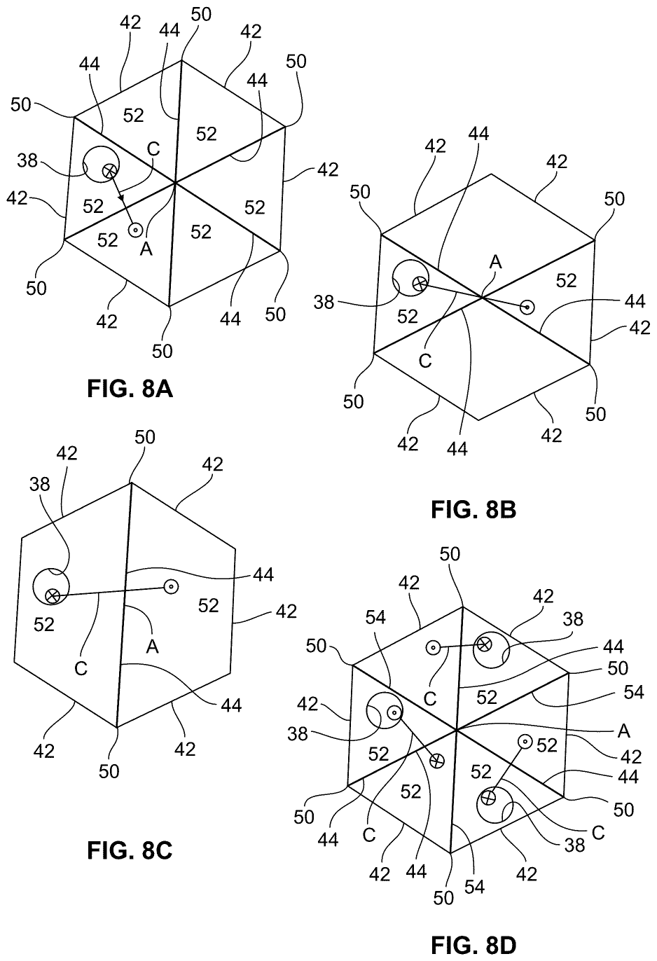

By “joined partitions” we mean at least two internal partitions 44 joined together at the central axis A of the tubular polygonal cell 36. For example, FIG. 8c illustrates two internal partitions 44 (or alternatively two half partitions) joined together at the central axis A, FIG. 8b illustrates four internal partitions 44 joined together at the central axis A and FIGS. 6, 7, 8a and 9 illustrate six internal partitions 44 joined together at the central axis A. Each internal partition 44 of the joined partitions may extend in a transverse direction between internal faces 48 of two side walls 42, between two joining edges 50 or between a joining edge 40 and an opposite side wall.

This is the case, for example, with the configuration of the hexagonal cell 36 in FIGS. 4 to 8a-8c, where each partition 44 extends between the central axis A and an edge 50 joining two of the side walls 42.

In the case of a cell 36 comprising only identical internal partitions 44 and having a number of side walls 42 which is even, as is the case of a cell of hexagonal section 36 such as that shown in FIGS. 4 to 8a-8c, each partition 44 is aligned with another identical partition 44.

In the example shown here, the internal partitions extend transversely between the axis A and the edges 50 joining the side walls 40, defining as many pockets 52 communicating with each other as there are side walls 42.

In this case, each pocket 52 communicates with all the others and with the hole 38.

The cell 36 may also comprise a smaller number of partitions 44 alternating with internal walls of the same height H1 as the side walls of the cell 36 to define pairs of pockets 52 each associated with a hole 38.

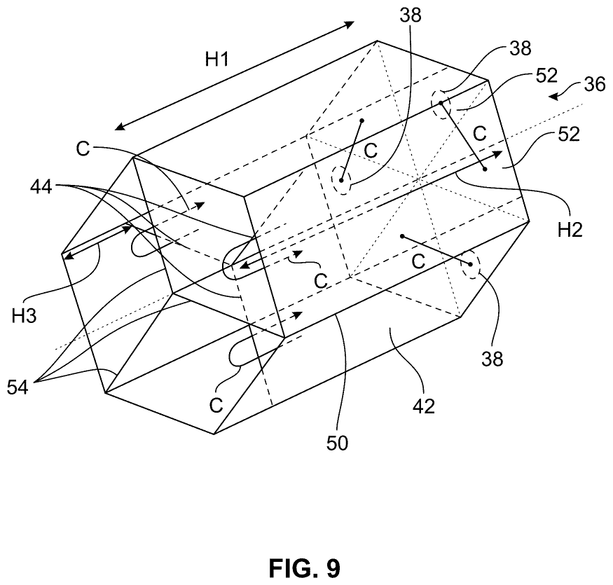

This is the case of the configuration shown in FIGS. 8d and 9, which represent a cell 36 comprising an even number of side walls 42, half as many partitions 44 as side walls 42, and internal walls 54 of the same first height H1 as the side walls 42, which alternate around the central axis A with said partitions 44.

In this way, the partitions 44 and internal walls 54 delimit pairs of adjacent communicating pockets 52 (in this case three pairs of communicating pockets 52, as the cell 36 is hexagonal in cross-section).

Each pair of communicating pockets 52 is isolated from the other pairs of communicating pockets 52 and communicates with a hole 38 formed in the first skin 30. The cell 36 is therefore supplied by three holes 36. In this case, the number of pairs of communicating pockets 52 is half the number of side walls 42.

Regardless of the embodiment chosen here, and in a non-limiting manner of the invention, the sound waves therefore travel in cell 36 along a path C that is approximately twice the first height H1 of the side walls 42 of the cell 36 and its cavity 40. Consequently, in order to attenuate sound waves satisfactorily, this path must have a length λ/4 equal to a quarter of the emitted wavelength, so we can propose a cell with a first height H1 equal to an eighth of the wavelength λ of the sound to be attenuated, i.e. λ/8 .

For example, the first height H1 is between 20 and 50 mm.

The second height H2 is greater than half the first height H1 and at least 5 mm less than or equal to the first height H1.

As a result, it is preferable to have a core 34 that is half as thick as a conventional core 34.

The core 34 can be obtained in different ways depending on its material.

If the latter is metallic or thermoplastic, the cells 36 of the core 34, the side walls 42, and said at least one internal partition 44, or even the internal walls 54, can be obtained by an additive manufacturing method.

However, for a thermoplastic material, it is more economical for the cells of the core 34 and the side walls 42 to be obtained in one step by extrusion of a plastic material, for said at least one internal partition 44 or even said at least one internal wall 54 to be obtained also but independently in another step by extrusion of a plastic material, and then for said at least one internal partition 44 and/or said at least one internal wall 54 to be added and welded into each cell 36.

The cells 36 of the core 34 can also be obtained by supplying a conventional honeycomb material in which at least one insert forming said at least one partition 44 is arranged.

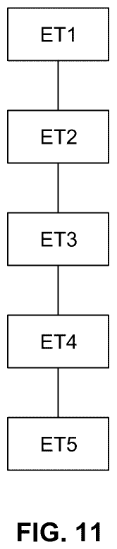

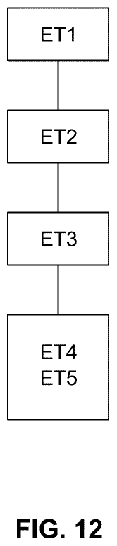

In this configuration, as illustrated in FIGS. 11 and 12, an attenuation panel 28 of the type described above can be manufactured using a method comprising a first step ET1 of manufacturing the first skin 30.

In a second step ET2, the second skin 32 is manufactured.

In a third step ET3, the core 34 is manufactured by additive manufacturing, by extrusion and welding, or by supplying a conventional honeycomb material in which inserts forming the internal partitions 44 are arranged.

The method also comprises a fourth step ET4, in which the first and second skins 30, 32 are attached to the core 34 by welding, brazing or gluing.

It should be noted that the fourth stage can be carried out in a number of different ways. It is possible to attach the first and second skins 30, 32 to the core 34, or first attach the core 34 to one of the two skins 30, 32, then attach the other skin 32 or 30 to the core 34.

In a first variant of this method, as shown in FIG. 11, it follows the numerical order of the steps and it is therefore at the end of the fourth step ET4 that the method comprises a fifth step ET5 of drilling or punching the first skin 30, which allows to produce in said first skin 30 the holes 38 which each open into a pocket 52 of a polygonal cell 36 of the core 34.

Alternatively, the method may involve a step ET5 of drilling or punching the first skin 30 during step ET4 before the final assembly of the two skins 30, 32, this drilling or punching may take place with the skin 30 assembled with the core 34 if it is the first to be assembled, or may take place on the skin 30 alone, before it is assembled with the core 34 already assembled with the skin 32. Whichever variant is chosen, it is not necessary to position the holes 38 in the first skin 30 in relation to the cells 36. If the drilling or punching pattern is regular and the pitch between the holes 38 is correctly defined, drilling the skin 30 will statistically generate enough suitably placed holes 38 to communicate with a sufficient number of pockets 50.

The invention therefore allows to have a turbomachine or turbomachine nacelle 10 comprising at least one gas flow duct F, P, S delimited by at least one wall comprising a panel 28 of the type described above. The use of such panels 28 enables them to be used in more compact turbomachines.

1. A sound attenuation panel for an aircraft turbomachine or turbomachine nacelle, said panel comprising a first skin, a second skin, and a core sandwiched between the first and second skins, said core comprising a plurality of tubular polygonal cells which each have an orientation (A) perpendicular to the first and second skins, each cell comprising an internal cavity that communicates with at least one hole formed in said first skin and is delimited by side walls extending between the first and second skins and perpendicularly to the first and second skins, these side walls having a first height (H1) equal to a distance between the first and second walls,
wherein each polygonal cell further comprises at least one internal partition inside its cavity, this internal partition extending from the first skin perpendicularly to the first and second skins at a second height (H2) less than the first height (H1), and transversely in the cavity between two side walls of the cell, this internal partition dividing the cavity into at least two adjacent pockets and delimiting between a free end of said partition and the second skin a passage allowing said at least two adjacent pockets to communicate with each other and with said hole, and
in that each polygonal cell is a regular polygonal cell having a central axis (A) and in that it comprises at least two partitions joined along said central axis (A).

2. The sound attenuation panel according to claim 1, wherein at least two partitions extend transversely between internal faces of two opposite side walls of the cell.

3. The sound attenuation panel according to claim 1, wherein at least two partitions extend transversely between an edge joining first and second side walls and a third side wall opposite the first and second side walls.

4. The sound attenuation panel according to claim 1, wherein said at least two partitions extend transversely between an edge joining first and second side walls and an edge joining third and fourth side walls.

5. The sound attenuation panel according to claim 1, wherein each polygonal cell is a hexagonal cell.

6. The sound attenuation panel according to claim 1, wherein each cell comprises as many internal partitions joined along the central axis (A) as there are side walls.

7. The sound attenuation panel according to claim 1, wherein each cell comprises an even number of side walls and in that the internal partitions extend transversely between said axis (A) and the edges joining the side walls, delimiting as many pockets communicating with one another as there are side walls.

8. The sound attenuation panel according to claim 1, wherein each cell comprises an even number of side walls, half as many partitions as side walls, and internal walls of the same first height (H1) as the side walls, which alternate about the central axis (A) with said partitions so as to delimit pairs of adjacent communicating pockets, each pair of communicating pockets being isolated from the other pairs of communicating pockets and communicating with a hole in the first skin, the number of pairs of communicating pockets being half the number of side walls.

9. The sound attenuation panel according to claim 1, wherein the first height (H1) is equal to one eighth of a wavelength of a sound to be attenuated.

10. The sound attenuation panel according to claim 1, wherein the first height (H1) is between 20 and 50 mm.

11. The sound attenuation panel according to claim 1, wherein the second height (H2) is greater than half the first height (H1) and at least 5 mm less than or equal to the first height (H1).

12. A method of manufacturing a sound attenuation panel according to claim 1, the method comprising:
a first step (ET1) of manufacturing a first skin,
a second step (ET2) of manufacturing a second skin,
a third step (ET3) of manufacturing the core by additive manufacturing, by extrusion and welding, or by supplying a conventional honeycomb material in which at least one insert forming said at least one partition is arranged,
a fourth step (ET4) of fixing the first and second skins to the core by welding, brazing or gluing, and
a fifth step (ET5) of drilling the first skin, producing holes in said first skin, each of which opens statistically into a pocket of a polygonal cell of the core.

13. A turbomachine comprising at least one gas flow duct (F, P, S) delimited by at least one wall comprising a sound attenuation panel according to claim 1.
